(19) United States
(12) Patent Application Publication
(10) Pub. No.: US 2003/0103246 A1
(43) Pub. Date: Jun. 5, 2003

(54) System and method for providing unobtrusive human visible information on a print

(75) Inventors: John R. Fredlund, Rochester, NY (US); Robert P. Cloutier, Spencerport, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/020,538

(22) Filed: Nov. 30, 2001

(51) Int. Cl. B41F 1/00; G06F 15/00; H04N 1/387

(52) U.S. Cl. 358/450; 358/1.14; 358/1.9

(57) ABSTRACT

The present invention relates to a system and method for providing human visible, detectable and/or readable information on an image side of a print. The human visible, detectable and/or readable information is provided in a manner that is not obtrusive, and positioned in such a way that it is unlikely to obscure any important details of the image. In the system and method of the invention, image pixel data is modified in accordance with predetermined parameters to create a slight variation from the original image pixels. The results is an obtrusive addition of text or information to an image which is provided on a print without disrupting the aesthetic appreciation of the image and which blends in with the image.

### FIELD OF THE INVENTION

The present invention relates to the field of digital photofinishing and more particularly to a system and method for providing unobtrusive human visible information on the image side of a print.

### BACKGROUND OF THE INVENTION

Digital photofinishing is well known. In one aspect of digital photofinishing, image files from scanned film or digital memory are written to paper by any number of well-known printing means.

Printing data on images is also well known. In particular, date backs for cameras have been devised that expose the date onto the image bearing area of photographic film. When printed, an image of the date is superimposed on the image. The resulting text is printed in such a fashion that the date will appear against almost any background. Therefore, by necessity, the text is obtrusive, does not blend in with the background image, and is positioned in a portion of the image defined by the design of the camera.

In some instances, a user may desire that the date or other text does not appear on the image side of the print. Co-pending patent application Ser. No. 09/076,533 filed May 12, 1998, describes a system that scans film, identifies the date exposed on the film by the date back of the camera, and then interpolates the image data to eliminate the date imprint. If a user still desires that the date appears on the print but not on the image, the date can be moved to a different location on the photograph and reproduced. For example, dates and other information can be printed on the back of images. This provides an unobtrusive means for providing information, but necessitates that the print be free to be viewed from the back side. This is inconvenient for any image that has been placed in an album.

A further known system for showing unobtrusive text is taken from a video perspective, and specifically relates to channel indicators on television screens where the channel you are viewing appears on a portion of the screen. However, channel indicators on television screens always appear at the same place on the screen and are always at the same viewable threshold level. Further, channel indicators on television screens are not image dependent.

### SUMMARY OF THE INVENTION

The present invention relates to a system and method of providing human visible information on the image side of a print. In the system and method of the present invention, the information is provided in such a manner that it is not obtrusive, and is positioned in such a way that it blends in with the background image and it is unlikely to obscure any important details of the image.

Further, in the system and method of the present invention, the unobtrusive human visible information is capable of being moved to any desired area within the image.

In the system and method of the invention, image pixel data is modified in accordance with predetermined parameters to create a slight variation from the original image pixels. This results in an unobstructive addition of text to an image and the text can be provided on prints without disrupting the aesthetic appreciation of the image.

The present invention therefore relates to a method of providing human visible information on an image. The method comprises the steps of: selecting a location on an image for human visible information; analyzing pixels of the image at the location that will be used to create the human visible information to determine pixel values of the analyzed pixels; adjusting the pixel values of the analyzed pixels by a predetermined amount; and printing the image with the human visible information thereon. The human visible information is printed with pixel values that differ from pixel values of an image area which surrounds the human visible information or that differ from pixel values of the replaced pixels.

The present invention further relates to a system for providing human visible information on an image. The system comprises: a computer device adapted to analyze pixels of an image that will be used to create human visible information to determine pixel values of the analyzed pixels, and further adapted to adjust the pixel values of the analyzed pixels by a predetermined amount; and a printing device adapted to print the image with the human visible information thereon. The human visible information is printed with pixel values that differ from pixel values of an image area which surrounds the human visible information or that differ from pixel values of the replaced pixels.

The present invention further relates to a system for providing human visible information on an image which comprises: means for analyzing pixels of an image that will be used to create human visible information to determine pixel values of the analyzed pixels, and adjusting the pixel values of the analyzed pixels by a predetermined amount; and means for printing the image with the human visible information thereon.

The present invention further relates to a system for providing human visible information on an image which comprises a computer device adapted to analyze pixels of an image that will be used to create human visible information to determine pixel values of the analyzed pixels, with the computer device being further adapted to adjust the analyzed pixel values of the pixels by a predetermined amount; and a storage device adapted to store the image with the human visible information thereon. The human visible information is stored with pixel values that differ from pixel values of an image area which surrounds the human visible information.

### BRIEF DESCRIPTION OF THE DRAWINGS

FIG. 1 illustrates a photofinishing system in accordance with the present invention;

FIG. 2 is a flow chart which describes an example of how image files are combined with human visible information in the present invention;

FIG. 3 is an example of an image location where unobtrusive human visible information is to be added;

FIG. 4 is an example of the image of FIG. 3 having the unobtrusive human visible information;

FIG. 5 is a further example of an image to which information is to be added;

FIG. 6 shows the image of FIG. 5 with the information thereon; and

FIG. 7 is a further example of adding human visible information in accordance with the present invention.

### DETAILED DESCRIPTION OF THE INVENTION

The invention describes a system and method for providing human visible information on the image side of a print. Within the context of the present invention, human visible information refers to human readable information such as numbers, letters, etc. which can be read by humans; and/or human detectable information such as bar codes which are visible and can be detected by a human, but are generally not considered to be human readable.

The information is provided in such a manner that it is not obtrusive, and positioned in such a way that it blends in with the background image and it is unlikely to obscure any important details of the image.

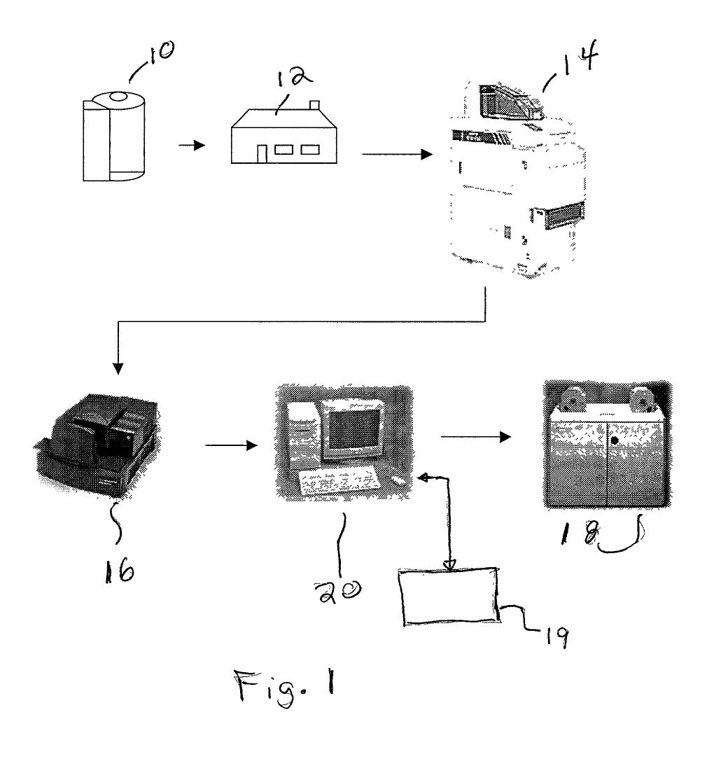

Referring to FIG. 1, in the system and method of the present invention, a roll of photographic film 10 is provided to a photofinisher 12. Photofinisher 12 develops film 10 at a processor 14 and scans the roll of film 10 at a scanner 16 to provide image files for printing at a printer 18. A computer, controller or central processing unit 20 is used to monitor and control the scanning, image modification and printing process of the present invention. Information such as a date is provided to the photofinisher by the provider of the roll of film, the film itself in the form of a magnetic code as provided by, for example, the Advantix film system from Eastman Kodak Company, or by a means as simple as reading a calendar. The information is combined with the image on the film, and the resulting combination is printed at printer 18. The system of FIG. 1 can also include a storage device 19 which can be adapted to store an image having information thereon.

FIG. 1 shows one example for obtaining images and essentially shows a digital photofinishing method. It is noted that the present invention is not limited to the system shown in FIG. 1. For example, the present invention is also applicable to images printed from the internet or electronic image files obtained from digital cameras.

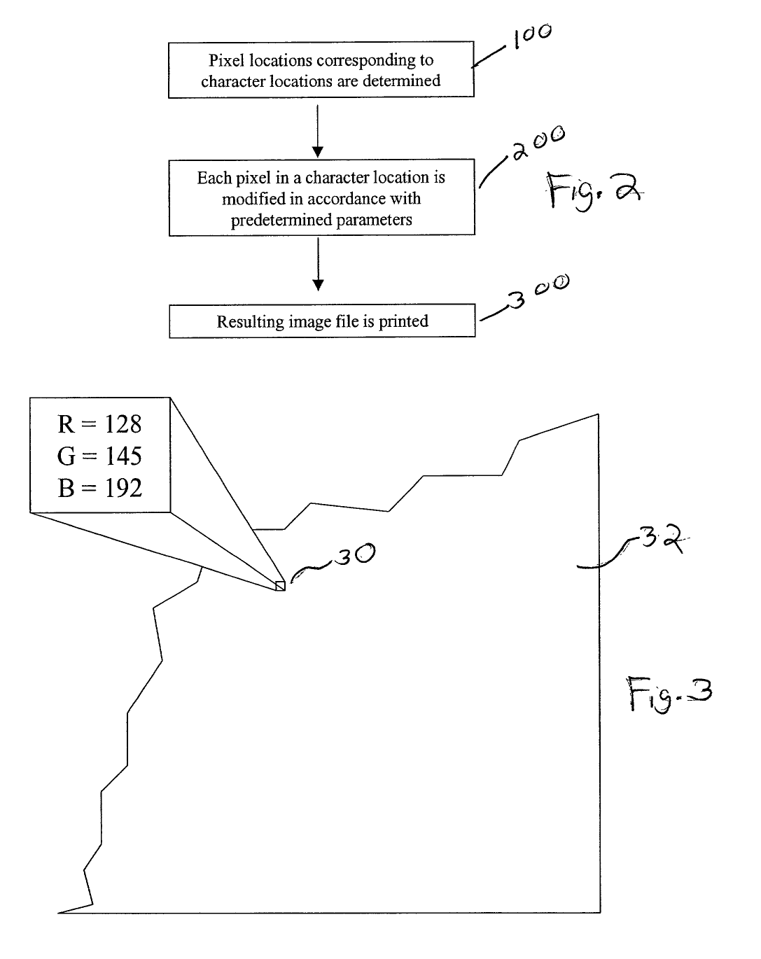

FIG. 2 shows a flow chart which describes the manner in which the image files are combined with the human visible information. As noted above, in addition to film, the images could be obtained from the internet or image files from a digital camera. In one feature of the invention and using FIG. 1 as an example, the scanned data file is analyzed at computer or controller 20. As a result of the analysis, computer or controller 20 could be adapted to modify the image file in accordance with the spatial relationship of the characters that are used to print the information and the colorimetric value of pixels of the image. As shown in the flow chart of FIG. 2, the first step in the system and method of the present invention is to determine the pixel locations that will correspond to the human visible character location (step 100). Each pixel in the character location is then modified in accordance with predetermined parameters to create the unobtrusive human visible characters (step 200). Thereafter, the resulting image file along with the unobtrusive human visible characters are printed or can be stored in storage device 19 (step 300).

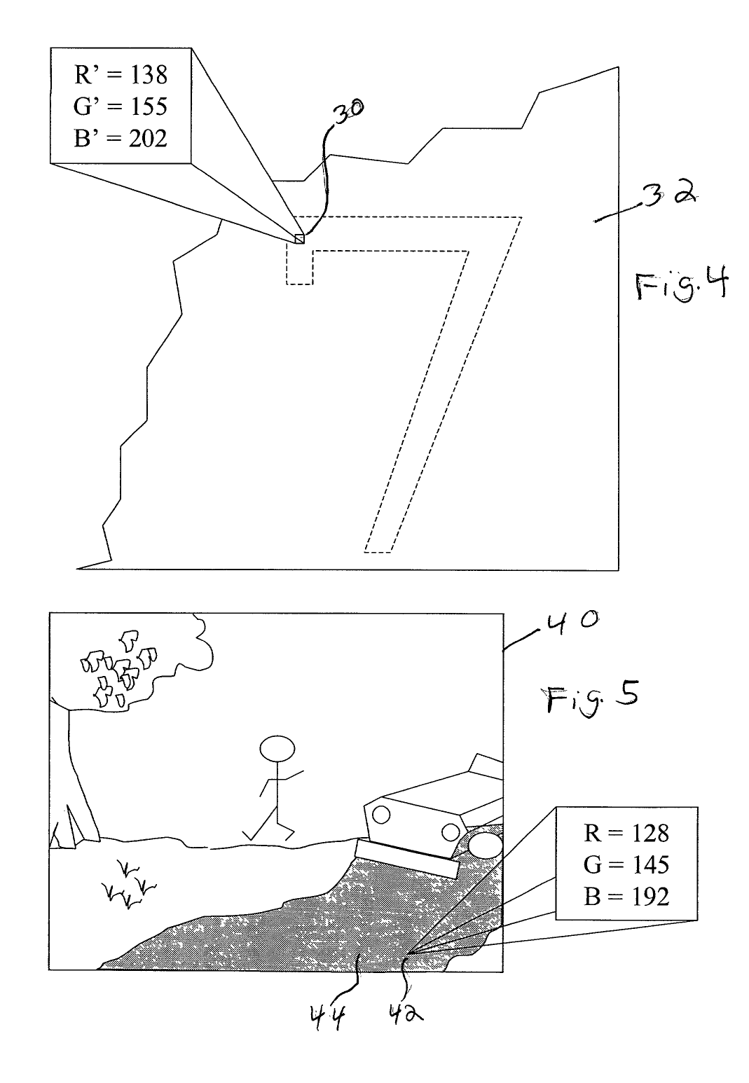

As an instructive example reference is made to FIGS. 3 and 4. In the example of FIGS. 3 and 4, the character “7” which is human visible and readable is to be printed on a portion of an original image 32 in an unobtrusive manner. First, a location 30 on image 32 which will be analyzed for the location of the character “7” is selected. This selection may be made arbitrarily or by a process that will be described later. Next, the pixels of original image 32 that will be changed or replaced to create human visible and readable character “7” are analyzed at location 30 to determined color values. In this case the color values are 128 in the red channel, 145 in the green channel, and 192 in the blue channel. For ease of understanding, it will be assumed that all the pixels in questions are of this value, although this is very unlikely to be the case in practice. The color value of each analyzed pixel is then increased or decreased by a predetermined value dependent on the threshold of perceptibility desired by a user. The threshold of perceptibility refers to the level of visibility that is desired for the human visible and readable character “7”. In a preferred embodiment, the human visible and readable character “7” is in a selected location in the image and hardly visible under normal viewing conditions so as to not obscure the details of the image. At the same time, the human visible and readable character “7” should be recognizable when the print is carefully or closely reviewed. In this case the color value of each pixel is increased by 10 as shown in FIG. 4. The resulting pixels, now of values 138 in the red channel (R′), 155 in the green channel (G′), and 202 in the blue channel (B′) will have a slightly different appearance than that of the image pixels they have replaced, and thus, will be human visible and readable and at the same time unobtrusive. In this way, the human visible and readable character “7” will tend to blend in with the surrounding background, so as not to be recognizable under normal viewing conditions and recognizable when closely reviewed.

In the example of FIG. 4, the human visible and readable information or character is the number “7”. However, the human visible information or character could be a name, a letter, a symbol, etc. Note that while these pixels will be human visible, they are only slightly different from the pixels they have replaced, and thus, are not obtrusive. Slightly different generally means adjustment of the pixel values by less than 10% of the full scale. Further, although the example refers to human visible and readable character “7”, other types of information such as a bar code can be provided. In the case where information such as a bar code is provided on the image, this would be considered visual and human detectable since bar codes are not considered human readable. Also, although the example of FIG. 4 describes increasing the color value of each pixel by a value of 10, the present invention is not limited thereto. For example, only one color value for one color channel could be increased, and the remaining color values could remain unchanged. Using the example of FIG. 4, a user could increase the color value of the red channel from 128 to 138, and leave the color value of the green channel at 145 and the blue channel at 192. As a further example, a user can selectively increase the color value of one color channel and decrease the color value of another color channel. Thus, with the system of the present invention, a user can selectively choose to increase or decrease the color value of any one of the individual red, green or blue color channels.

Therefore, the predetermined value that is used to adjust the pixel value may not be a constant. For example, the value may change differently in each channel. As described above, the resulting pixels in the example can be changed to values of 138 in the red channel (R′), 125 in the green channel (G′), and 192 in the blue channel (B′). In this case, the red channel has been adjusted upward, the green channel has been adjusted downward, and the green channel has not been changed. Also, the predetermined value may be a different value according to the original pixel value. For example, if the original value (R) is 128 in the red channel, the modified value may be increased by 10 to 138 (R′). However, if the original value (R) is 225 in the red channel, the modified value may be decreased by 10 to 215 (R′). This adjustment may be determined by well known look up table techniques.

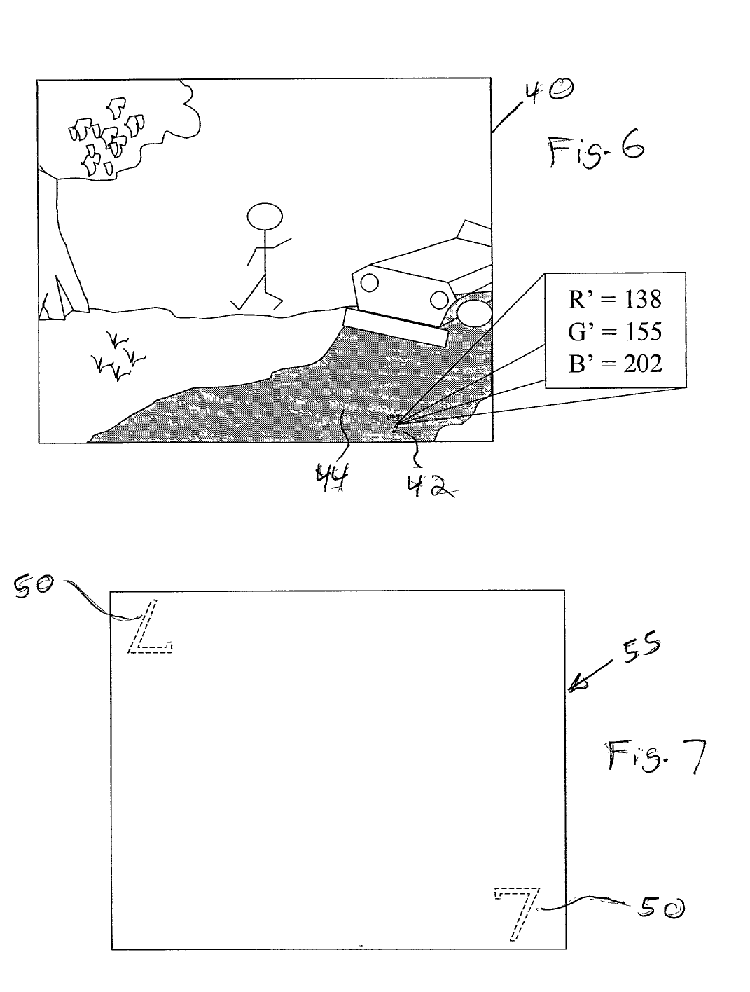

FIGS. 5 and 6 more clearly illustrate the features of the system and method of the present invention with respect to an image. As illustrated in FIG. 5, in a feature of the present invention, a location can be selected for the human visible character. The selection could be made by the user or automatically made in response to an analysis of the image. In a preferred feature of the present invention, the selection is preferably a darker area without detail so that the human visible character can be hardly visible under normal reading or viewing conditions. In the example of the image of print 40, such a location could be location 42 within a dark area 44. In the same manner as described above, after the location is selected, in one example of the present invention, the pixels of the image that will be changed to create the human visible character are analyzed to determined color values. In the same manner as also noted above, these pixel values could be 128 in the red channel (R), 145 in the green channel (G) and 192 in the blue channel (B). Thereafter, as shown in FIG. 6, the color value of each analyzed pixel is increased by, for example, a value of 10. The resulting pixels now will be of values 138 in the red channel (R′), 155 in the green channel (G′) and 202 in the blue channel (B′) as shown in FIG. 6. The result will be a character “7” within dark area 44 which would have a slightly different appearance than that of the image pixels that have been replaced. Character “7” would be visible, and unobtrusive to the image. More specifically, the character “7” would be hardly visible under normal viewing conditions but would still be within the image, so as to be visible and recognizable when carefully reviewed. Therefore, in the example of FIG. 6, after the pixel values are adjusted, the character “7” will appear at location 42 on print 40 as shown.

Of course, it is recognized that the human visible characters can be placed anywhere within the image as desired by the user. For example, the location could be a lighter location and the increase in pixel value could be less than it would be in a darker location, so as to create an unobtrusive character within the lighter location. Additionally, the present invention is not limited to increasing the pixel values, and it is recognized that the pixel values could be selectively increased or decreased to create the unobtrusive visible information. Further, a user can select to change only one or two of the pixel values and leave the remaining color channel or channels unchanged. In essence, the present invention permits a user to select his threshold of perceptibility with respect to the human visible character information, by selecting whether he or she wants to increase or decrease the pixel values of specific color channels, and by selecting where they would like to place the human visible and unobtrusive character information.

Additionally, although the present invention shows the human visible and readable character “7” as an example, the present invention is not limited thereto. Within the concept of the present invention, a user can select to include logos, bar codes, trademarks, words, general text (i.e., APS IX frame titles), greeting card text, graphic applications, etc. as the human visible unobtrusive print.

Note that many different colorimetric properties can be changed to yield the desired result. A slight brightness shift has been described, but a change in other characteristics such as hue or saturation could also yield a human visible but unobtrusive effect.

Another means of providing unobtrusive human visible information is to average the colorimetric values of the pixels in a character or near the character to provide a colorimetric value. The character can then be reproduced using this average value. This technique has the advantage of being less intensive computationally, however, it may produce unwanted results if there are large changes in the colorimetric values of the pixels being replaced.

A means of automatically selecting a location and providing unobtrusive human visible information is by means of a spatial analysis of the image file at computer or controller 20. In this method, the image is analyzed to determine low-interest areas. These may be a portion of the image or areas without high frequency detail, such as a heavily shadowed area, or areas where the detail is repetitive, such as an area of grass, and not likely to be of consequence in the aesthetic appreciation of the image. Dark portions of the image may be preferred due to the response of the human visual system. Once the low-interest area is determined, characters are placed in the area. In the example of FIGS. 5 and 6, the low interest area location is location 42. As a further option, certain areas of an image where the human visible information would not be desirable could be avoided. For example, it would be preferable to not include the human visible information on faces in an image. Therefore, in the present invention, the optimum location of the image for the human visible information could be an area where faces or flesh are not detected. Ansel Algorithms which include face or flesh detection technology could be used to find areas of flesh or faces in an image to avoid placing the human visible information in these areas.

Digital printing means also provide an opportunity to ensure that the information is printed at the extreme edges of an image. The film-back system could not do this due to the tolerances built up between film, camera, and photofinishing equipment. Digital printers are not constrained in this manner and can assure that the information is printed at a small size at the edges of the image. Hence the image analysis previously described need not be for the entire image, but only along an edge that is expected to be the bottom of the image. If the determination of the image bottom is not robust or conclusive, then information 50 may be printed in more than one orientation as shown by print 55 of FIG. 7.

Because the information is unobtrusive, as previously described, the technique may be used to put more information on the print than presently provided. In addition to the date, image number, sequence number, roll number or other information maybe included. Logos for the photofinisher, retail or manufacturer may also be included.

As a further option, URLs pointing to image locations on the Internet may be printed, or a password allowing access to the file may also be included. As a still further option, a crop box may be included to suggest preferred enlargements or reprints.

Therefore, the human visible unobtrusive information can be at least one of an image/series number, a URL, a password, a company logo and a crop box on front of the print.

In a further feature of the invention, information may be selectively placed into an image. An example is names of individuals. A consumer may submit an image file with information of this type placed as desired on the image using a standard color overlay, and the photofinisher can incorporate the data at the selected locations in the unobtrusive manner according to the invention.

Within the context of the invention, there may be a desire to reprint a hardcopy image containing unobtrusive text. The text is visible, readable or detectable on the basis of consistent variation from surrounding pixels. A detector can be devised by a programmer skilled in the art that will show variations in the image consistent with the invention. If unobtrusive text is determined to be in the image and the divergence from existing pixels can be determined, the text can be removed before the reprint is made. This may be advantageous if the reprint is intended as a gift or enlargement. Additionally, the text removed from the image file may be resized and repositioned as desired by the customer.

Therefore, the present invention provides for a system and method of inserting human visible, detectable and/or readable characters or information on an image side of a print. The characters or information can be provided in a manner that is not obtrusive, and positioned in such a way that it is unlikely to obscure any important details of the image. The present invention is applicable to images captured by digital cameras, hybrid cameras or traditional cameras. The digital camera can insert the desired data into the image file by the previously described methods prior to saving the file. In the case of a digital camera, and with reference to FIG. 1, computer device 20 could include a digital camera or input from a digital camera. Storage device 19 would then be adapted to store the image with the human visible, detectable and/or readable information, such that the human visible information can be stored with pixel values that differ from pixel values of an image area which surrounds the human visible information.

Additionally, the system and method of the present invention can be practiced in a photofinishing environment or a minilab environment. An advantage of the present invention is that a user can select a threshold of perceptibility for the unobtrusive human visible character or information. For example, the user can select an increase or decrease in pixel values to create the human visible unobtrusive character or information. With respect to this feature, the mechanism for creating the human visible unobtrusive character or information can be provided on a camera. For example, in a traditional camera, information as to the threshold or degree of perceptibility and the location for the unobtrusive print can be written or recorded on the film for use by the photofinisher. Additionally, in a digital camera this information can be in the form of data which accompanies the image.

The present invention is also applicable to traditional date-back cameras which exposes data in the image area. In such a system, the date that is exposed on the image by the traditional date-back camera can be removed by a known method, such as that disclosed in co-pending application Ser. No. 09/076,533 filed May 12, 1998. Thereafter, the system and method of the present invention can be used as described above, to create the unobtrusive human visible character or information. As a still further option, the images can be submitted electronically to the photofinisher with instructions to create the unobtrusive character or information.

The invention has been described in detail with particular reference to certain preferred embodiments thereof, but it will be understood that variations and modifications can be effected within the spirit and scope of the invention.

What is claimed is:

1. A method of providing human visible information on an image, the method comprising the steps of:
selecting a location on an image for human visible information;
analyzing pixels of the image at said location that will be used to create the human visible information to determine pixel values of said analyzed pixels;
adjusting the pixel values of said analyzed pixels by a predetermined amount; and
printing the image with said human visible information thereon, wherein said human visible information is presented with pixel values which are different from pixel values of an image area which surrounds said human visible information.

2. A method according to claim 1, wherein said adjusting step comprises increasing the pixel values of said analyzed pixels.

3. A method according to claim 1, wherein said adjusting step comprises decreasing the pixel values of said analyzed pixels.

4. A method according to claim 1, wherein said adjusting step comprises changing the pixel value of at least one color channel of said analyzed pixels.

5. A method according to claim 1, wherein said adjusting step comprises adjusting the pixel values of said analyzed pixels by different amounts in each color channel.

6. A method according to claim 1, wherein said adjusting step comprises adjusting the pixel values of said analyzed pixels by different amounts according to a value of an original pixel.

7. A method according to claim 1, wherein said adjusting step comprises adjusting the pixel values of said analyzed pixels by less than 10% of full scale.

8. A method according to claim 1, wherein said selecting step comprises the step of:
determining an optimum location for said human visible information based on a spatial analysis of said image.

9. A method according to claim 8, wherein said optimum location of said image for said human visible information is at least one of an area without high frequency detail on said image, an area of repetitive detail in the image, and a dark portion area of the image.

10. A method according to claim 8, wherein said optimum location of said image for said human visible information is at least an area where faces or flesh are not detected.

11. A method according to claim 1, wherein said analyzing step comprises analyzing a portion of the image.

12. A method according to claim 1, wherein said human visible information is at least one of a number, a URL, a bar code, APS IX frame titles, text graphics, a password, a company logo and a crop box on front of the print.

13. A method according to claim 1, wherein said human visible information is human readable and/or human detectable.

14. A system for providing human visible information on an image, the system comprising:
a computer device adapted to analyze pixels of an image that will be used create human visible information to determine pixel values of said analyzed pixels, said computer device being further adapted to adjust the analyzed pixel values of said pixels by a predetermined amount; and
a printing device adapted to print the image with said human visible information thereon, wherein said human visible information is printed with pixel values that differ from pixel values of an image area which surrounds the human visible information.

15. A system according to claim 14, wherein said computer device is further adapted to determine an optimum location for said human visible information based on a spatial analysis of said image.

16. A system according to claim 15, wherein said optimum location of said image for said human visible information is at least one of an area without high frequency detail on said image, an area of repetitive detail in the image, and a dark portion area of the image.

17. A system according to claim 14, wherein said human visible information is at least one of a number, a URL, a password, a bar code, APS IX frame titles, text graphics, a company logo and a crop box on front of the print.

18. A system according to claim 14, wherein said human visible information is human readable and/or human detectable.

19. A system for providing human visible information on an image, the system comprising:
means for analyzing pixels of an image that will be used to create human visible information to determine pixel values of said analyzed pixels, and adjusting the pixel values of said analyzed pixels by a predetermined amount; and
means for printing the image with said human visible information thereon.

20. A system for providing human visible information on an image, the system comprising:
a computer device adapted to analyze pixels of an image that will be used to create human visible information to determine pixel values of said analyzed pixels, said computer device being further adapted to adjust the analyzed the pixel values of said pixels by a predetermined amount; and a storage device adapted to store the image with said human visible information thereon, wherein said human visible information is stored with pixel values that differ from pixel values of an image area which surrounds the human visible information.

21. A system according to claim 20, wherein said computer device comprises a digital camera.

22. A system according to claim 20, wherein said human visible information is human readable and/or human detectable.

23. A method of providing human visible information on an image, the method comprising the steps of:
selecting a location on an image for human visible information;
analyzing pixels of the image at said location that will be used to create the human visible information to determine pixel values of said analyzed pixels;
adjusting the pixel values of said analyzed pixels by a predetermined amount; and
printing the image with said human visible information thereon, wherein said human visible information is presented with pixel values which are different from the pixel values that they have replaced.

24. A method according to claim 23, wherein said adjusting step comprises increasing the pixel values of said analyzed pixels.

25. A method according to claim 23, wherein said adjusting step comprises decreasing the pixel values of said analyzed pixels.

26. A method according to claim 23, wherein said selecting step comprises the step of:
determining an optimum location for said human visible information based on a spatial analysis of said image.

27. A method according to claim 26, wherein said optimum location of said image for said human visible information is at least one of an area without high frequency detail on said image, an area of repetitive detail in the image, and a dark portion area of the image.

28. A method according to claim 23, wherein said analyzing step comprises analyzing a portion of the image.

29. A method according to claim 23, wherein said human visible information is at least one of a number, a URL, a bar code, APS IX frame titles, text graphics, a password, a company logo and a crop box on front of the print.

30. A method according to claim 23, wherein said human visible information is human readable and/or human detectable.

31. A method according to claim 23, wherein said adjusting step comprises adjusting the pixel values of said analyzed pixels by different amounts in each color channel.

32. A method according to claim 23, wherein said adjusting step comprises adjusting the pixel values of said analyzed pixels by different amounts according to a value of an original pixel.

33. A method according to claim 23, wherein said adjusting step comprises adjusting the pixel values of said analyzed pixels by less than 10% of full scale.

34. A method according to claim 26, wherein said optimum location of said image for said human visible information is at least an area where faces or flesh are not detected.
